(19) United States
(12) Patent Application Publication
(10) Pub. No.: US 2011/0273393 A1
(43) Pub. Date: Nov. 10, 2011

(54) Method and Apparatus for Distributed Computing with Proximity Sensing

(76) Inventors: Wai Keung WU, Hong Kong (HK); Siu Man CHAN, Hong Kong (HK)

(21) Appl. No.: 12/775,335

(22) Filed: May 6, 2010

(51) Int. Cl. G06F 3/045; H04B 1/38

(52) U.S. Cl. 345/174; 455/566

(57) ABSTRACT

The present invention relates to method and apparatus for receiving and processing one or more inputs from multiple mobile devices. In some embodiments, a mobile device identifies its neighboring mobile devices. Based on the information of neighboring mobile devices for each mobile device, a topology of multiple mobile devices is developed. If an input is provided to a mobile device, the mobile device will determine if the input is a supported distributed event. If the input is a supported distributed event, the mobile device will gather the inputs from other mobile devices and aggregate them into an aggregate input. Based on the aggregate input, an output is generated to control one or more mobile devices in the topology.

### TECHNICAL FIELD

The present invention relates generally to multiple devices interacting with one another, and more particularly to touch screen user interfaces as well as to distributed computing and proximity sensing.

### BACKGROUND

Touch screen has become increasingly popular as an input to many electronic devices. A user can input his instructions to devices in such an intuitive and easy way that he touches the display screen and selects what he sees on the display screen.

Other touch sensitive input devices such as touch pad also facilitate human interaction with electronic devices. By touching on a touch detection area, a user can give instructions to control devices and operate software applications or programs conveniently.

Accordingly, there is a need for enhancing touch inputting. For example, in addition to touch, gestures have been allowed to represent various input instructions, for example, in U.S. Pat. No. 7,657,849, gestures to perform unlocking are disclosed. In addition to using a single touch as an input instruction, multi-touch is used to represent a richer variety of input commands; for example, in U.S. Pat. No. 7,479,949, multi-touch implementation is disclosed. Increasing techniques of input controls have been performed through touch inputs such as scaling and rotating as disclosed in U.S. Pat. No. 7,469,381, and through typing as disclosed in U.S. Pat. No. 7,614,008. Even if a device does not support multi-touch initially, certain methods are available to provide multi-touch interface capability for devices equipped with only single-touch physical interfaces and/or associated driver software, for example, as disclosed in US Patent Application Publication US 2009/0309847. The above citations are hereby incorporated by reference in their entirety.

Still, there is a great need for more innovative touch inputting so that more complex and advanced input instructions can be accommodated. For example, there is a need for an input command that is composed of various touch inputs from multiple devices. There is a further need for a technique that allows the touch inputs from multiple devices to control the same application so that the same application can be shared among different users and be controlled by them simultaneously. Moreover, existing touch inputting technologies are still constrained by factors such as the size of the touch detection area. For example, items available for selection are limited by the size of touch screen of one device and it is too cumbersome to scroll or move around to find a desired item.

### SUMMARY OF THE INVENTION

A first aspect of the present invention is to allow multiple devices to provide inputs to one or more shared operations, programs or applications.

A second aspect of the present invention is to allow greater variety of instructions to be represented by multi-touch, for example, an instruction being represented by the aggregated multi-touch inputs from multiple devices. Various orders of inputs and various combinations of inputs allow many more instructions to be available.

According to the first aspect of the present invention, a mobile device for receiving and processing a distributed input event from a plurality of mobile devices is provided. The mobile device has an input interface, which may be a touch screen in some embodiments. The mobile device also has one or more processors and one or more memory units. Each memory unit may store one or more programs, which may be codes, functions, software, applications, configured to be executed by the one or more processors. These programs include instructions for identifying one or more neighboring mobile devices within a search range; instructions for developing a topology of the multiple mobile devices based on the information of neighboring mobile devices from each of the multiple mobile devices; instructions for determining if the input is a supported distributed input event in response to an input to the mobile device; and if the input is not a supported distributed input event, the mobile device will make use of instructions for generating an output for one or more of the multiple mobile devices to operate on. Those distributed input event that are supported are predetermined.

According to the second aspect of the present invention, if the input is a supported distributed input event, then the mobile device will wait for other inputs from other mobile devices in the topology. After receiving the other inputs over a period of time, the mobile device will aggregate all the relevant inputs into an aggregate input. Based on the aggregate input, the mobile device will generate an output for one or more of the multiple mobile devices to operate on.

The mobile device may be any electronic device or portable multifunctional device, or may be any heterogeneous device which can communicate with its nearest neighbor via some means (e.g., IR, wired, RF wireless).

For such a mobile device, all communications or exchange of data are assumed to be conducted with its nearest neighbor only and there is no direct means to send or receive any message or data from any device not in its direct neighbor list (i.e. hop by hop communications). Another aspect of the present invention is to provide a distributed communications method which distributes messages among mobile devices by unicast, multicast or broadcast by a hop-by-hop communications mechanism. The mobile device exchanges data with others using a transceiver. In some embodiments, the mobile device may have a transceiver located at each side of the mobile device so as to exchange data with neighboring devices along that side.

One further aspect of the present invention is to compute the centroid of the topology of the multiple mobile devices. Given the centroid of the topology of the multiple mobile devices, a coordinate can be assigned to each of the multiple mobile devices. Therefore, when a distributed application is executed on a collection/subset of devices in the topology, these mobile devices can be identified by their respective coordinates.

Another aspect of the present invention is to provide a method of aggregating relevant input stimuli reliably and consistently by retransmitting data with exponential timeout.

Another aspect of the present invention is provide a method of identifying master and slave(s) if the aggregated input stimuli from different devices correspond to the distributed input event.

In certain embodiments, the present invention is implemented in a system library in user space or kernel space. One non-limiting example of the system library is the one used in an MID, for example, Android MP2.

In accordance with certain embodiments, a distributed multi-touch is enabled in software applications such as an image viewer application. Such distributed multi-touch is implemented to zoom in and zoom out.

Other aspects of the present invention are also disclosed as illustrated by the following embodiments.

### BRIEF DESCRIPTION OF THE DRAWINGS

These and other objects, aspects and embodiments of this claimed invention will be described hereinafter in more details with reference to the following drawings, in which:

FIG. 1 depicts a schematic diagram illustrating multiple devices with touch screen in accordance with some embodiments.

FIG. 2 depicts a schematic diagram illustrating a mobile device with multiple transceivers in accordance with some embodiments.

FIG. 3 illustrates exemplary exchange of data among mobile devices in accordance with some embodiments.

FIG. 4 illustrates an exemplary method of developing the topology for a mobile device in accordance with some embodiments.

FIG. 5 depicts a flowchart for processing a distributed input event in accordance with some embodiments.

FIG. 6 depicts an exemplary operation among multiple mobile devices during a distributed input event.

FIG. 7 depicts communication of a zoom in/zoom out command among multiple devices in a topology.

FIG. 8 depicts use of a number of multi-touch inputs from multiple devices to form a distributed event for zoom in/zoom out.

### DETAILED DESCRIPTION OF THE INVENTION

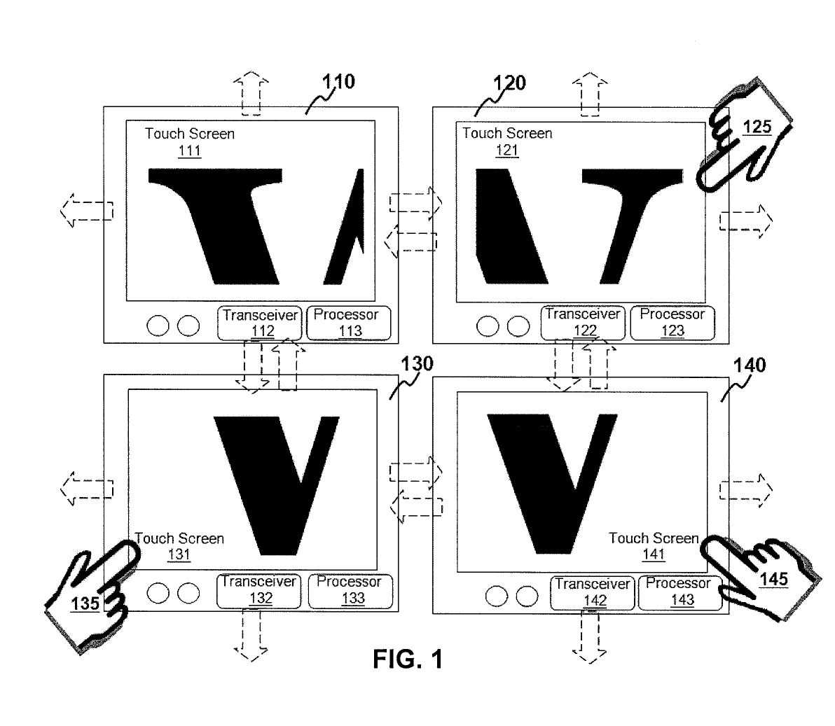

FIG. 1 depicts a schematic diagram illustrating multiple devices with touch screens in accordance with some embodiments of the present invention. In some embodiments, more than one mobile device is placed in a proximity to another mobile device. In general, the proximity refers to a search range covered by the sensing devices or the transceivers of a mobile device. For the example shown in FIG. 1, there are four mobile devices, namely, mobile device 110, mobile device 120, mobile device 130 and mobile device 140. Each mobile device includes at least a touch screen 111, 121, 131, or 141; a processor 113, 123, 133, or 143; and a transceiver 112, 122, 132, or 142. The processor is configured to execute and perform any instructions, processes, and operations associated with the mobile device. The processor is configured to interact with or control other components associated with the mobile device such as memory (not shown), touch screen and transceiver. The processor is capable of inputting and outputting data to and from other components associated with the mobile device.

The touch screen is a non-limiting example of a touch interface which is available for each mobile device. Such a touch interface includes, but is not limited to, a touch sensitive area, or touch pad, or any devices or technologies capable of detecting presence and location of a touch or capable of providing touch/gesture control including those which are not yet developed as of the filing date of this document. Some non-limiting examples of suitable input devices or technologies include resistive touch screen, surface acoustic wave technology, capacitive touch screen, surface capacitance technology, projected capacitance technology, strain gauge/force panel technology, optical imaging technology, infrared (IR) sensing technology, dispersive signal technology, acoustic pulse recognition, and coded LCD/bidirectional screen technology. Some non-limiting examples of the touch input may be input through a wide variety of contact such as fingers, hand portions, styluses, adaptive touch devices for physically challenged users, etc. In certain embodiments, in addition to the touch input, a non-touch input may also be one of the non-limiting examples for the input stimulus. One non-limiting example of the non-touch input may include voice, capturing motion of eyeball or capturing motion of hand by a camera whereas a computer program analyses the images or video of the motion and has them mapped to the corresponding input. Some non-limiting examples of mobile device which incorporates touch inputs include mobile Internet device (MID), smart phone, laptop, mobile computing device and the like.

The touch screen may be a separate component or may be integrated with a display device. Some non-limiting examples of suitable display devices or technologies include liquid crystal displays (LCDs), such as thin film transistor (TFT-LCD) displays and HPA-LCD displays, light-emitting diode (LED) displays, organic light-emitting diode (OLED) displays, and electroluminescent displays (ELDs) or the like.

In some embodiments, the touch screen may be a single-touch input device or a multi-touch input device.

Both internal and external transceivers can be adopted for the system as disclosed herein. The internal or external transceivers suitable for the system may be in any format or technology known to a person skilled in the art. Some non-limiting examples of suitable transceiver or technologies include IR transceivers, radiofrequency (RF) transceivers, Bluetooth transceivers, Wi-Fi transceivers, any wired or wireless communicating devices, or any transceivers or technology which is capable of proximity sensing and data communication.

In some embodiments, each mobile device identifies the relative positions of other mobile devices in the topology by exchanging data among them. The relative positions may be represented in terms of two-dimensional planes or even three-dimensional spaces. Each position may be represented in x-coordinate, y-coordinate or z-coordinate or various combinations of different coordinates.

In some embodiments, the exchange of data among different mobile devices is performed by a hop-by-hop mechanism. Each mobile device has its own list of neighboring mobile devices. For example, mobile device 110 has a list of neighboring devices. Depending on the range of search area of a transceiver or different setting, mobile device 110 may only consider those mobile devices which are directly adjacent to its four sides as neighbors. For example, mobile device 120 is a neighbor of mobile device 110 because it is directly adjacent to the right side of the mobile device 120. Mobile device 130 is a neighbor of mobile device 110 because it is directly adjacent to the bottom side of the mobile device 110. However, mobile device 140 is not considered to be a neighbor of mobile device 110 because mobile device 140 is not directly adjacent to any of the four sides of device 110.

Under the hop-by-hop mechanism, a mobile device exchanges data with other mobile devices by directly connecting to those neighboring mobile devices on the list and indirectly connecting to non-neighboring mobile devices through the neighboring mobile devices. For example, mobile device 110 exchanges data with mobile devices 120 by directly connecting with mobile device 120. In order to exchange data with non-neighboring mobile devices, mobile device 110 checks with its neighboring mobile devices (120, 130) to see if any of its neighboring mobile devices (120, 130) are in direct connection with the non-neighboring mobile devices which it wants to exchange data with. Therefore, mobile device 110 can exchange data with mobile device 140 by sending data to mobile devices 120 or 130 through which the data is sent to mobile device 140 and receiving data from mobile devices 120 or 130 through which the data is received from mobile device 140.

In some embodiments, the hop-by-hop communications are performed through any wireless connection or any wired connection. Some non-limiting examples of wireless connections include Bluetooth, IR, Wi-Fi, ZigBee and the like. Some non-limiting examples of wired connections include IEEE 1394, RS-232, USB, and LAN.

In some embodiments, multiple mobile devices, e.g. 110, 120, 130, 140, are used to display a picture. In one exemplary example, a picture of letter “W” is displayed on four multiple mobile devices 110, 120, 130, and 140. Different users can use their finger tips 125, 135, and 145 (or other input devices) to control the display of the picture. Some non-limiting examples of control include resizing, rotating/flipping, dragging, selecting, and editing by watching and touching on touch screens 111, 121, 131, and 141 respectively. For example, if finger tip 135 drags the letter “W” to the left by 50 pixels on the touch screen 131, the images as shown on mobile devices 110, 120, 130, 140 will be shifted to the left by 50 pixels.

In some embodiments, each mobile device aggregates the relevant input stimuli reliably and consistently and decides whether the aggregated input corresponds to the supported distributed input event. Each mobile device includes a memory or computer readable medium which stores a database of relevant input stimuli and a database of the supported distributed input events. When an input stimulus occurs on one mobile device, the input stimulus is converted into an input data by the mobile device. The input data may be associated with a time stamp. The input data is exchanged among mobile devices which are either in direct connection or in indirect connection. Each mobile device can determine if the input data belongs to a relevant input stimulus before exchanging the input data with other mobile devices or after receiving any input data from other mobile devices by checking the database of relevant input stimuli. If it is determined that the input data is not relevant, the input data will not be exchanged with other mobile devices. If a mobile device receives an input data which is not relevant from other mobile devices, the input data will be disregarded. Using the relevant input data either from other mobile devices or from itself, a mobile device aggregate the relevant input data into an aggregated input. Each mobile device can determine if the aggregated input belongs to a supported distributed input event by checking the database of the supported distributed input event.

In some embodiments, the input stimulus may be a touch or a gesture. Some non-limiting examples of the gesture may be one or more touches, taps, swipes, drags, rotations, or any movement on a touch screen over a period of time. In some embodiments, the aggregation of input data may be in accordance with the time stamps associated with the input data, for example, in chronological order. Or the aggregation of input data may be in accordance with the number of hops from the source mobile device to the destination mobile device. The input stimulus is not limited to the present embodiment which is based on touching and may be based on non-touch input or non-touch gesture depending on requirements. Some non-limiting examples for non-touch input or non-touch gesture may include voice, capturing motion of eyeball or capturing motion of hand by a camera whereas a computer program analyses the images or video of the motion and has them mapped to the corresponding input.

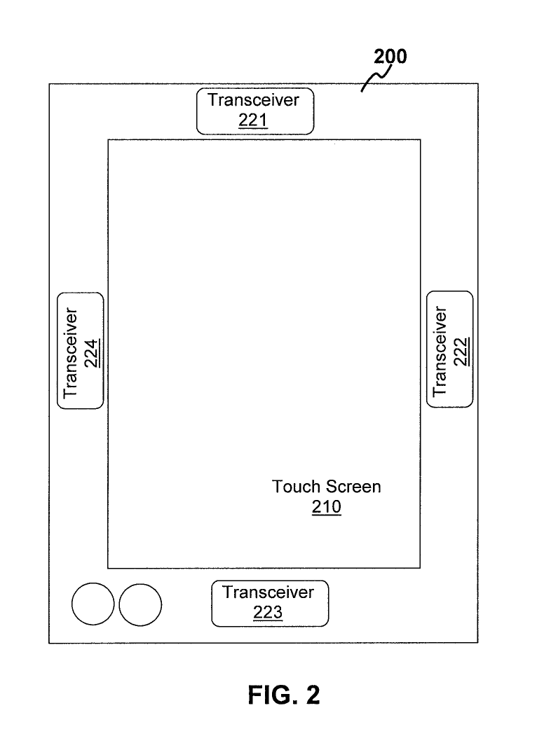

FIG. 2 depicts a schematic diagram illustrating a mobile device with multiple transceivers in accordance with some embodiments. In some embodiments, a mobile device 200 may include one or more transceivers. In some embodiments, one or more of mobile devices 200 in a system of multiple mobile devices 200 may include one or more transceivers. In some embodiments, each of the transceivers is located at each side of the mobile device 200. For example, if a touch screen 210 on the mobile device 200 has four sides, namely, the top side, the left side, the right side and the bottom side, one transceiver 221 is located at the side of the mobile device 200 along the top side of the touch screen 210. One transceiver 222 is located at the side of the mobile device 200 along the right side of the touch screen 210. One transceiver 223 is located at the side of the mobile device 200 along the bottom side of the touch screen 210. One transceiver 224 is located at the side of the mobile device 200 along the left side of the touch screen 210.

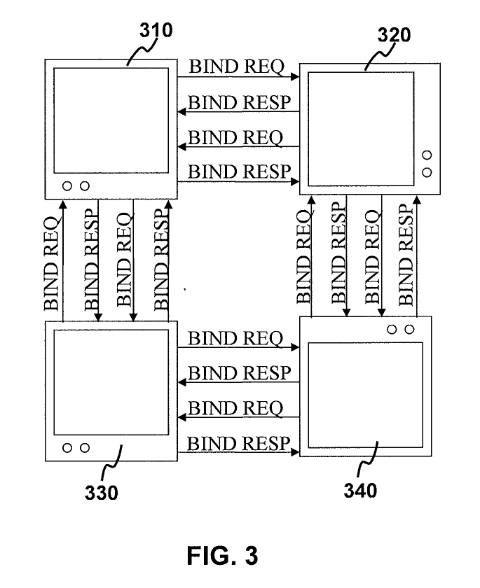

FIG. 3 illustrates an exemplary exchange of data among mobile devices in accordance with some embodiments. In these embodiments, data may include various messages such as, but not limited to, the following types of request (REQ) and response (RESP):
BIND—locate and find the neighbor (REQ/RESP)
ACT—distributed action to be triggered by the user input defined by application layer (REQ/RESP)
   SPREAD—action message distributed to other devices in the topology (REQ/RESP)

In some embodiments, one mobile device needs to identify its neighbors and the orientation of its neighbors by an exchange of a binding request (BIND REQ) and a binding response (BIND RESP) between the mobile device and each of its neighbors. A binding request/response is created based on the message exchange. The binding request/response is stored in each mobile device. Each binding request or binding response may contain the following entries:
Identifier of the source mobile device
Orientation of the source mobile device
Identifier of the destination mobile device
Orientation of the destination mobile device

In one non-limiting example, mobile device 310 sends a binding request to mobile device 320 in order to provide its identifier (MID 1) and its orientation relative to mobile device 320 (East) to mobile device 320 and request mobile device 320 to provide the identifier and the orientation relative to the mobile device 310. The mobile device 320 responds by sending a binding response to mobile device 310 in order to confirm the identifier and the orientation of mobile device 310 and provide its identifier (MID 2) and its orientation relative to mobile device 310 (North) to mobile device 310. Under this scenario, the binding request is in the form of “BIND REQ (“MID1”, EAST, ?, ?)” and the binding response is in the form of “BIND RESP (“MID1”, EAST, “MID2”, NORTH)”. The same binding information can be generated if the binding request is initiated from mobile device 320 first and mobile device 310 responds to the binding request by providing a binding response to mobile device 320.

The binding information (“MID1”, EAST, “MID2”, NORTH) is distributed to other mobile devices reliably by flooding through the remaining transceivers of mobile devices 310 and 320 (that is, the transceivers other than the transceiver being used to communicate between mobile devices 310 and 320).

In some embodiments, the reliable transmission of any packet or message is guaranteed by retransmission with exponential timeout. In one non-limiting embodiment, a CRC (cyclic redundancy check) is used to check the corruption of packet (REQ) in computer network. If the packet is corrupted, no acknowledgment (RESP) will be provided by the receiver and the sender will resend the packet after a period of time. In case the packet (REQ) is lost during transmission, the sender will resend the packet as well if no acknowledgment (RESP) is received after a period of time. The period of time is also known as timeout and its duration increases exponentially after every timeout.

In some embodiments, the distribution of the binding information can be performed through broadcast directly to all listening mobile devices instead of using hop-by-hop communication if RF wireless is available between the mobile devices which exchange the binding information.

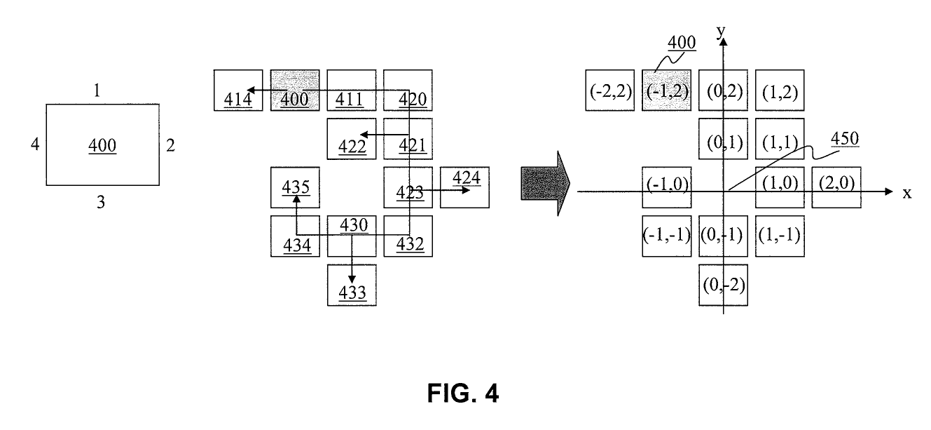

FIG. 4 illustrates an exemplary method of developing the topology for a mobile device in accordance with some embodiments. After collecting all the binding requests/responses, each mobile device can derive the x, y coordinates (to the nearest integer) relative to the centroid of the topology and its orientation. The topology can be developed by various approaches such as depth-first search or breadth-first search. In one embodiment, the priority of searching is in the order of north 1, east 2, south 3 and west 4. For example, mobile device 434 searches for any neighboring device along the north direction first so that it will find mobile device 435. Mobile device 400 searches for any neighboring device along the east direction and it will find mobile device 411 after searching along the north direction and cannot find any mobile device in the north direction. Mobile device 420 searches for any neighboring device along the south direction and finds mobile device 421 after searching along the north direction and the east direction. Mobile device 400 searches for any neighboring device along the west direction and finds mobile device 414 after searching along the north direction, the east direction and the south direction. For example, a topology of the mobile devices available will be developed by mobile device 400 in the following sequence: mobile device 411, mobile device 414, mobile device 420, mobile device 421, mobile device 422, mobile device 423, mobile device 424, mobile device 432, mobile device 430, mobile device 433, mobile device 434, and mobile device 435. The topology is updated from time to time, for example, when a new mobile device gets close to these neighboring mobile devices or when one of the neighboring mobile devices leaves.

The coordinates will be assigned to each mobile device in the topology based on the location of the mobile device 400 and shared among all the mobile devices. Consequently, all the mobile devices share the common coordinate system. For example, if the coordinates of mobile device 400 is set to be (0,0) initially, the coordinates of mobile device 411 will be (1,0), the coordinates of mobile device 422 will be (1,−1) and so on.

After the topology of the mobile devices available, also known as a search tree, is created, each mobile device determines the centroid 450 of the search tree based on the topology of the network and its coordinates relative to the centroid 450. In one embodiment, suppose there are a number of devices with coordinates (xᵢ,yᵢ) where i=1 . . . n. The centroid 450 will be:
x-coordinate of centroid=Σ(xᵢ)/n
y-coordinate of centroid=Σ(yᵢ)/n

The mobile device closest to the coordinates of the centroid is the centroid device. If two or more mobile devices have the same distance, the mobile device with lowest ID, is chosen to be the centroid. The ID for a mobile device can be any device suitable, for example, the MAC address or the device ID. In one embodiment, the coordinates of mobile devices in the topology is shifted in accordance with the coordinates of the centroid 450 so as to set the coordinates of the centroid 450 to be (0,0). Consequently, the coordinates of mobile device 400 will be (−1,2) and the coordinates of mobile device 411 will be (0,2) as shown in FIG. 4.

In some embodiments, a mobile device may distribute a message reliably to a mobile device in hop-by-hop unicast. After the network topology is developed as described above, each mobile device in the network knows the topology and the shortest path to each single mobile device in the topology is calculated. The source ID (identity) of the message is assigned to be the device ID of the mobile device which sends the message (the sender). If the message is a unicast message, the destination ID of the message is assigned to be the device ID of the mobile device which is the intended recipient of the message.

The sender (root node) distributes the message to its child nodes (neighboring mobile devices) that follow the shortest path to the intended recipient. The intermediate nodes along the shortest path receive the message and then forward the message to their child nodes in accordance with the shortest path.

The reliable distribution of message is achieved by having the acknowledgement response (ACK RESP) from the intended recipient to the sender. If no acknowledgement response is received by the sender within certain time span, the message will be resent. The unicast message is useful in exchange message between two devices to establish a session.

In some embodiments, one mobile device may distribute a message reliably to other mobile devices in a hop-by-hop broadcast/multicast. If a message is a broadcast message, the destination ID of the message is assigned to be broadcast mode. The mobile device which broadcasts the message (the sender/root node) distributes the messages to all its child nodes. Each child node receives the message and then forwards the message to all of its child nodes except the ones from which it receives the message.

If this message is a multicast message, the device IDs of multiple mobile devices are assigned to the destination ID of the message. The intermediate nodes in the topology receive the message and then forward the message to their child nodes following the shortest paths to the mobile devices which device IDs are the destination ID of the message.

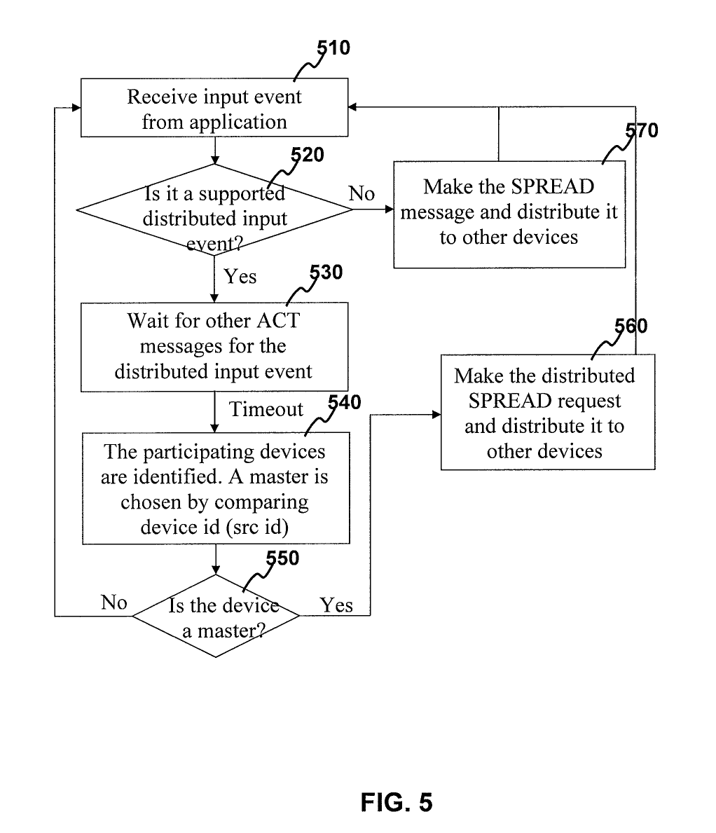

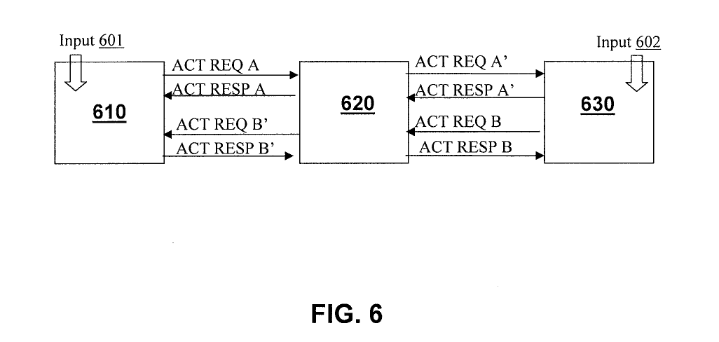

In some embodiments, one or more mobile devices may operate distributively upon a distributed input event. One mobile device aggregates input stimuli from other mobile devices in the network topology into an aggregated input. FIG. 5 depicts a flowchart of how a distributed input event is processed in accordance with some embodiments. FIG. 6 depicts an exemplary operation among multiple mobile devices during a distributed input event. When a mobile device 610 receives an input stimulus when running an application, such as a long press as a non-limiting example, mobile device 610 receives an input event 601 from the application 510. As in step 520, mobile device 610 checks with the application layer to determine whether the input event 601 is a supported distributed input event. If not, mobile device 610 need not wait for other input events from other mobile devices for aggregating all input events into the supported distributed input event. Therefore, the mobile device 610 can determine what action to be taken based on the input event 601 and send the SPREAD message to other mobile devices as in step 570, for example, if such action requires involvement from other mobile devices. If the input event 601 is a supported distributed input event, an ACT REQ is sent to other mobile devices, for example, to mobile device 620 as ACT REQ A and to mobile device 630 as ACT REQ A′. When an ACT REQ message is received, mobile devices respond by sending an ACT RESP message. For example, mobile device 620 will respond by sending ACT RESP A to mobile device 610 and mobile device 630 will respond by sending ACT RESP A′ to mobile device 620.

In the meantime, mobile device 610 waits for other ACT REQ messages from other mobile devices as in step 530. An ACT REQ message represents an input stimulus. In other words, each mobile device waits for input events from other devices to aggregate them together to generate a distributed input event message. When the time period is over, the participating mobile devices are identified and a master device is chosen arbitrarily among the participating mobile devices as in step 540 if the mobile device receives more than one ACT REQ message. Some non-limiting examples of the ways of choosing a mobile device to be the master device may include comparing device ID and using the lowest ID as the master device, or using the mobile device at the centroid as the master device. The device ID may be the source ID of each ACT REQ such as the MAC address or may be the user-defined ID. The master device is responsible for coordinating the creation and distribution of the distributed input event message. Therefore, as in step 550, if a mobile device is not a selected to be a master device, it will simply wait for other input event or instructions from the master device and these mobile devices are known as slave devices. The master device collects the ACT REQ from slave devices over the certain period of time and combines them into an aggregate input. Subsequently, the master device distributes a SPREAD message based on the aggregate input to other mobile devices as in step 560 so that a distributed action can be carried out among the mobile devices.

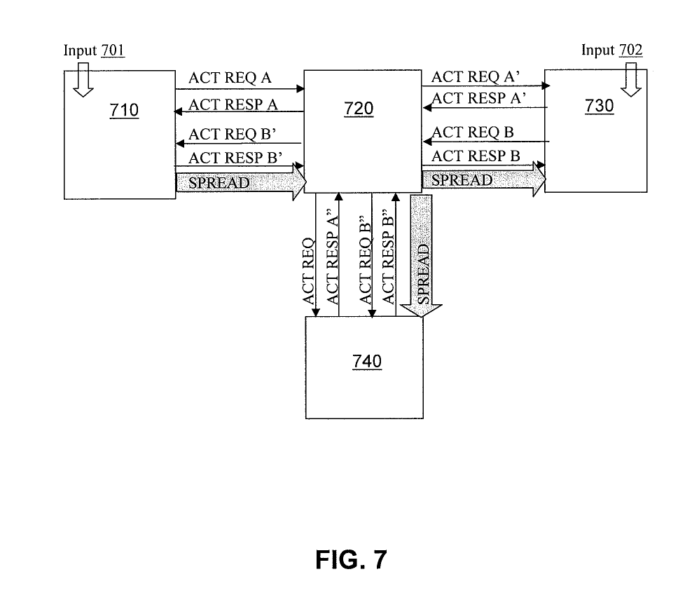

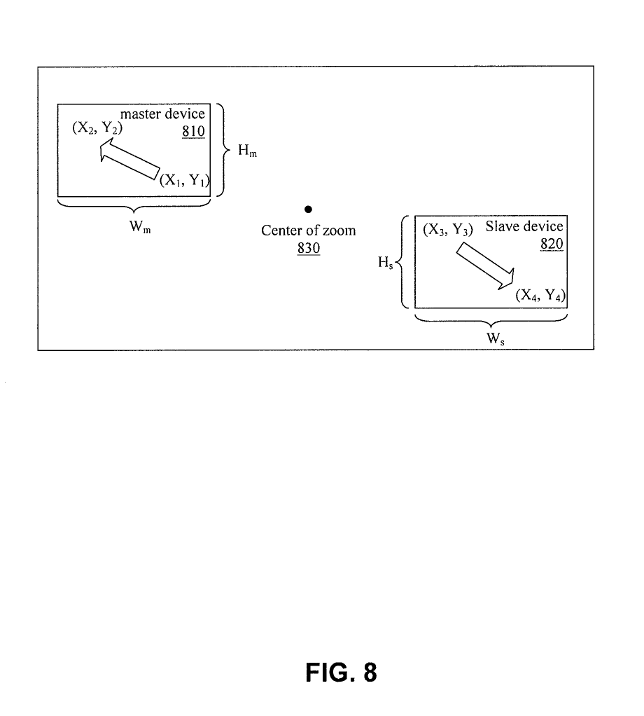

In some embodiments, a distributed input event may be used as an input instruction such as zoom in/zoom out. FIG. 7 depicts how a zoom in/zoom out command is communicated and handled by multiple devices in a topology. FIG. 8 depicts how a number of multi-touch inputs from multiple devices are used to form a distributed event for zoom in/zoom out.

For example, a user moves his finger (or other input device such as a stylus) from a certain point (X₁,Y₁) to another certain point (X₂,Y₂) on the touch screen of mobile device 710. This finger movement triggers an input stimulus 701.

For example, another user moves his finger from a certain point (X₃,Y₃) to another certain point (X₄,Y₄) on the touch screen of mobile device 730. This finger movement triggers an input stimulus 702.

With the input stimulus 701, an input event is generated by the application of mobile device 710. Mobile device 710 checks with its application layer to see if the input event needs to be aggregated with other input events from other mobile devices, i.e., to check if the input event is a supported distributed input event. If not, mobile device 710 simply sends a SPREAD message to other mobile devices to command them to take any necessary action. If the input event is a supported distributed input event, mobile device 710 sends an ACT REQ message to others and waits for a certain period of time to collect other ACT REQ message from other mobile devices in order to form the aggregate input.

With the input stimulus 702, an input event is generated by the application of mobile device 730. Mobile device 730 checks with its application layer to see if the input event needs to be aggregated with other input events from other mobile devices, i.e., to check if the input event is a supported distributed input event. If not, mobile device 730 simply sends a SPREAD message to other mobile devices to command them to take any necessary action. If the input event is a supported distributed input event, mobile device 730 sends an ACT REQ message to others and waits for a certain period of time to collect other ACT REQ message from other mobile devices in order to form the aggregate input.

When a certain period of time is over, mobile devices participating in the distributed input event are known as ACT REQ messages have propagated throughout the network. Based on the source ID of the ACT REQ messages, it is determined that mobile device 710 is the master device and it will aggregate various input events together to generate an aggregate input so that a SPREAD message can be generated based on the aggregate input to carry out the distributed input event.

For example, mobile device 710 is chosen as the master device 810. The master device 810 is responsible for calculating the zoom ratio and the centre of zoom. For example:

X coordinate of center of zoom 830 is computed by the processor of the master device 810 in accordance with the equation (1) below:

$$\frac{1}{2} \times ( \frac{( {X}_{1} + {X}_{2} ) / 2}{{W}_{m}} + ( {X}_{m} - 0.5 ) + \frac{( {X}_{3} + {X}_{4} ) / 2}{{W}_{s}} + ( {X}_{s} - 0.5 ) ) \qquad ( 1 )$$

where Wₘ is the width of master device 810 and Wₛ is the width of slave device 820. Xₘ is the x-coordinate of the master device 810 and Xₛ is the x-coordinate of the slave device 320.

Y coordinate of center of zoom 830 is computed by the processor of the master device 810 in accordance with the equation (2) below:

$$\frac{1}{2} \times ( \frac{( {Y}_{1} + {Y}_{2} ) / 2}{{H}_{m}} + ( {Y}_{m} - 0.5 ) + \frac{( {Y}_{3} + {Y}_{4} ) / 2}{{H}_{s}} + ( {Y}_{s} - 0.5 ) ) \qquad ( 2 )$$

where Hₘ is the height of master device 810 and Hₛ is the height of slave device 820. Yₘ is the y-coordinate of master device 310 and Yₛ is the y-coordinate of the slave device 820.

Degree of zooming is computed by the processor of the master device 810 in accordance with the equation (3) below:

\sqrt{(X₁−X₂)²+(Y₁−Y₂)²+(X₃−X₄)²+(Y₃−Y₄)²} (3)

The master device 810 broadcasts the SPREAD message which carries the zooming parameters, such as degree of zooming, centre of zoom, to other mobile devices in the topology.

Embodiments of the present invention may be implemented in the form of software, hardware, application logic or a combination of software, hardware and application logic. The software, application logic and/or hardware may reside on integrated circuit chips, modules or memories. If desired, part of the software, hardware and/or application logic may reside on integrated circuit chips, part of the software, hardware and/or application logic may reside on modules, and part of the software, hardware and/or application logic may reside on memories. In one exemplary embodiment, the application logic, software or an instruction set is maintained on any one of various conventional non-transitory computer-readable media.

Processes and logic flows which are described in this specification can be performed by one or more programmable processors executing one or more computer programs to perform functions by operating on input data and generating output. Processes and logic flows can also be performed by special purpose logic circuitry, e.g., an FPGA (field programmable gate array) or an ASIC (application-specific integrated circuit).

Apparatus or devices which are described in this specification can be implemented by a programmable processor, a computer, a system on a chip, or combinations of them, by operating on input date and generating output. Apparatus or devices can include special purpose logic circuitry, e.g., an FPGA (field programmable gate array) or an ASIC (application-specific integrated circuit). Apparatus or devices can also include, in addition to hardware, code that creates an execution environment for computer program, e.g., code that constitutes processor firmware, a protocol stack, a database management system, an operating system, a cross-platform runtime environment, e.g., a virtual machine, or a combination of one or more of them.

Processors suitable for the execution of a computer program include, for example, both general and special purpose microprocessors, and any one or more processors of any kind of digital computer. Generally, a processor will receive instructions and data from a read-only memory or a random access memory or both. The elements of a computer generally include a processor for performing or executing instructions, and one or more memory devices for storing instructions and data.

Computer-readable medium as described in this specification may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. Computer-readable media may include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

A computer program (also known as, e.g., a program, software, software application, script, or code) can be written in any programming language, including compiled or interpreted languages, declarative or procedural languages, and it can be deployed in any form, including as a stand-alone program or as a module, component, subroutine, object, or other unit suitable for use in a computing environment. A computer program can be deployed to be executed on one computer or on multiple computers that are located at one single site or distributed across multiple sites and interconnected by a communication network.

Embodiments and/or features as described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with one embodiment as described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The whole specification contains many specific implementation details. These specific implementation details are not meant to be construed as limitations on the scope of the invention or of what may be claimed, but rather as descriptions of features specific to particular embodiments of the invention.

Certain features that are described in the context of separate embodiments can also be combined and implemented as a single embodiment. Conversely, various features that are described in the context of a single embodiment can also be implemented in multiple embodiments separately or in any suitable subcombinations. Moreover, although features may be described as acting in certain combinations and even initially claimed as such, one or more features from a combination as described or a claimed combination can in certain cases be excluded from the combination, and the claimed combination may be directed to a subcombination or variation of a subcombination. Although various aspects of the invention are set out in the independent claims, other aspects of the invention comprise other combinations of features from the embodiments and/or from the dependent claims with the features of the independent claims, and not solely the combinations explicitly set out in the claims.

Certain functions which are described in this specification may be performed in a different order and/or concurrently with each other. Furthermore, if desired, one or more of the above-described functions may be optional or may be combined.

The above descriptions provide exemplary embodiments of the present invention, but should not be viewed in a limiting sense. Rather, it is possible to make variations and modifications without departing from the scope of the present invention as defined in the appended claims.

What is claimed is:

1. A mobile device for receiving and processing a distributed input event from a plurality of mobile devices, comprising:
an input interface;
one or more processors;
one or more memory units; and
one or more programs, wherein the one or more programs are stored in the one or more memory units and configured to be executed by the one or more processors, the programs including:
instructions for identifying one or more neighboring mobile devices within a search range;
instructions for developing a topology of the multiple mobile devices based on the information of neighboring mobile devices from each of the multiple mobile devices;
instructions for determining if the input is a supported distributed input event in response to an input to the mobile device; and
instructions for generating an output for one or more of the multiple mobile devices to operate on, and, based on the determination of whether the input is a supported distributed input event, when the input is a supported distributed input event, the mobile device is instructed to receive input from one or more of the neighboring mobile devices.

2. The mobile device as claimed in claim 1, wherein the programs further include instructions for computing a centroid of the topology of the multiple mobile devices.

3. The mobile device as claimed in claim 2, wherein the programs further include instructions for assigning a coordinate to each of the multiple mobile devices in accordance with the topology.

4. The mobile device as claimed in claim 1, wherein the programs further include instructions for, in response to the supported distributed input event, receiving and aggregating a plurality of inputs from the multiple mobile devices into an aggregate input; wherein
the output is generated in accordance with the aggregate input.

5. The mobile device as claimed in claim 1, wherein the input interface is a touch screen for generating the input.

6. The mobile device as claimed in claim 5, wherein the input is a multi-touch input using the touch screen which is a multi-touch input device.

7. The mobile device as claimed in claim 1, wherein the mobile device comprises a transceiver for exchanging data with the neighboring mobile devices.

8. The mobile device as claimed in claim 7, wherein each side of the mobile device comprises the transceiver which is exchanging data with the neighboring mobile devices along each side of the mobile device.

9. The mobile device as claimed in claim 8, wherein the mobile device exchanges data with other mobile devices by hop-by-hop communications.

10. The mobile device as claimed in claim 9, wherein the mobile device retransmits data with exponential timeout.

11. A method for receiving and processing one or more inputs from multiple mobile devices, comprising:
identifying one or more neighboring mobile devices within a search range by each of the multiple mobile devices;
developing a topology of the multiple mobile devices based on the information of neighboring mobile devices from each of the multiple mobile devices;
in response to an input to one of the multiple mobile devices, determining if the input is a supported distributed input event; and
generating an output for one or more of the multiple mobile devices to operate on, and, based on the determination of whether the input is a supported distributed input event, when the input is a supported distributed input event, the mobile device is instructed to receive input from one or more of the neighboring mobile devices.

12. The method as claimed in claim 11, further comprising:
computing a centroid of the topology of the multiple mobile devices.

13. The method as claimed in claim 12, further comprising:
assigning a coordinate to each of the multiple mobile devices in accordance with the topology.

14. The method as claimed in claim 11, further comprising:
in response to the supported distributed input event, receiving and aggregating a plurality of inputs from the multiple mobile devices into an aggregate input; wherein
the output is generated in accordance with the aggregate input.

15. The method as claimed in claim 11, wherein the mobile device comprises a touch screen for generating the input.

16. The method as claimed in claim 15, wherein the input is a multi-touch input using the touch screen which is a multi-touch input device.

17. The method as claimed in claim 11, wherein the mobile device comprises a transceiver for exchanging data with the neighboring mobile devices.

18. The method as claimed in claim 17, wherein each side of the mobile device comprises the transceiver which is exchanging data with the neighboring mobile devices along each side of the mobile device.

19. The method as claimed in claim 18, wherein the mobile device exchanges data with other mobile devices by hop-by-hop communications.

20. The method as claimed in claim 19, wherein the mobile device retransmits data with exponential timeout.
